(19) United States
(12) Patent Application Publication
(10) Pub. No.: US 2007/0154774 A1
(43) Pub. Date: Jul. 5, 2007

(54) Hydrophilized anode for a direct liquid fuel cell

(75) Inventor: Alexander Bluvstein, Dimona (IL)

Correspondence Address: GREENBLUM & BERNSTEIN, P.L.C., 1950 ROLAND CLARKE PLACE, RESTON, VA, 20191, US

(73) Assignee: More Energy Ltd., Lod (IL)

(21) Appl. No.: 11/325,466

(22) Filed: Jan. 5, 2006

(51) Int. Cl. H01M 4/92; H01M 4/96; H01M 8/08; H01M 4/88

(52) U.S. Cl. 429/40; 429/44; 429/46; 502/101

(57) ABSTRACT

An anode for a liquid fuel cell which has been subjected to a hydrophilization treatment in at least a part of a side thereof that is intended to contact the liquid fuel. This Abstract is not intended to define the invention disclosed in the specification, nor intended to limit the scope of the invention in any way.

### BACKGROUND OF THE INVENTION

1. Field of the Invention

The present invention relates to a hydrophilized anode for a Direct Liquid Fuel Cell (DLFC) which uses a hydride fuel and specifically, to an anode which provides rapid activation and high initial power of the fuel cell.

2. Discussion of Background Information

Direct liquid fuel cells are of considerable importance in the field of new energy conversion technologies. In the literature, the most frequently discussed liquid fuel for a DLFC appears to be methanol. The main disadvantages of Direct Methanol Fuel Cells (DMFCs) include the toxicity of methanol, the very poor discharge characteristics at room temperature and the complexity and cost due to high catalyst loading and poor performance.

Fuels based on (metal) hydride and borohydride compounds (hereafter sometimes collectively referred to as “hydride fuels”) such as, e.g., sodium borohydride (e.g., in alkaline solution) have a very high chemical and electrochemical activity. Consequently, DLFCs which use such fuels have extremely high discharge characteristics (current density, specific energy, etc.) even at room temperature.

Efficient operation of a DLFC which uses a (boro)hydride fuel requires continuous delivery of the (boro)hydride to the catalyst particles of the anode. For example, borohydride is electrochemically oxidized at the anode by direct reaction with formation of BO₂⁻ and water in accordance with the following equation:
BH₄⁻+8OH⁻=BO₂⁻+6H₂O+8e⁻ (1)

Since most hydride fuels comprise water and inorganic compounds such as, e.g., metal hydrides and/or borohydrides, it is desirable that an anode for a fuel cell which uses hydride fuels is as hydrophilic as possible to ensure an effective operation of the fuel cell. Also, rapid activation of a liquid fuel cell depends on the wetting rate of the anode, which increases with the hydrophilicity of the anode, at least as long as the fuel is hydrophilic.

The catalytically active layer of an anode for a liquid fuel cell usually comprises a catalyst on a particulate support (e.g., a catalytically active material dispersed in a porous particulate support such as, e.g., a porous carbon support) and a binder (usually a polymeric material such as, e.g., polytetrafluoroethylene (PTFE)). Examples of porous carbon supports include activated carbon, carbon black, graphite and carbon nanotubes. These materials may have different ratios of hydrophilic/hydrophobic properties; in general, they are more hydrophobic than hydrophilic. Activated carbons are usually more hydrophilic than carbon black and graphite. The catalytically active material dispersed in the support usually is hydrophilic. If a conventional binder such as, e.g., PTFE, is used, the binder is a hydrophobic material as well, which adds to the hydrophobic properties of the anode.

In view of the foregoing, it would be desirable to render the anode of a liquid fuel cell for use with a hydride fuel (i.e., a hydrophilic fuel) as hydrophilic as possible without, however, adversely affecting to any substantial extent desired anode properties such as electrocatalytic activity, mechanical integrity and electric conductivity of the active layer. This would be even more desirable with fuels which comprise alkaline substances such as, e.g., alkali metal hydroxides which tend to increase the surface tension of an (aqueous) fuel and thereby make it even more difficult to wet an anode which comprises hydrophobic materials.

### SUMMARY OF THE INVENTION

The present invention provides an anode for a liquid fuel cell, wherein at least a part of the side of the anode that is intended to contact the liquid fuel has been subjected to a hydrophilization treatment.

In one aspect, the anode of the present invention may comprise a catalytically active metal on a support. For example, the catalytically active metal may comprise one or more of Pt, Pd, Rh, Ru, Ir, Au and Re, and/or the support may comprise one or more of activated carbon, carbon black, graphite and carbon nanotubes. The anode may additionally comprise a binder such as, e.g., polytetrafluorethylene (PTFE), as well as a current collector.

In another aspect, at least the side of the finished anode which is intended to contact the liquid fuel may have been subjected to a hydrophilization treatment.

In another aspect, at least the support carrying the catalytically active metal may have been subjected to a hydrophilization treatment.

In yet another aspect, the anode of the present invention may have been subjected to a treatment with one or more hydrophilizing agents. Non-limiting examples of the hydrophilizing agents include anionic surfactants, cationic surfactants, non-ionic surfactants, polycarboxylic acids and salts thereof, oxy-acids and salts thereof, sugars, sugar alcohols, sugar derivatives and cellulose derivatives. For example, the hydrophilizing agent may comprise one or more of an alkyl sulfate, an alkyl sulfonate, a polyalkylene glycol, a polyalkylene glycol ether (usually with a weight average molecular weight of not higher than about 1,000), a homopolymer or copolymer of acrylic acid, a monomeric polycarboxylic acid or a salt thereof, a sugar such as glucose, fructose, xylose, sorbose, sucrose, maltose, lactose and galactose, a sugar alcohol such as sorbitol, xylitol, mannitol, maltitol, lactitol, galactitol and erythritol, a sugar derivative such as gluconic acid, and carboxymethyl cellulose and/or a salt thereof.

In another aspect, the anode may comprise from about 0.001 to about 5 mg/cm², e.g., from about 0.05 to about 0.5 mg/cm² anode of hydrophilizing agent.

In yet another aspect of the anode of the present invention, the hydrophilization treatment thereof may comprise cold plasma etching of at least that side of the finished anode which is intended to come into contact with the liquid fuel.

In a still further aspect of the instant anode, the real component of the impedance after 10 minutes of immersion of the anode in 6.6 M aqueous KOH may be not larger than about 50% of the real component of the impedance of the same anode that has not been subjected to the hydrophilization treatment and/or the real component of the impedance after 20 minutes of immersion of the anode in 6.6 M aqueous KOH may be not larger than about 75% of the real component of the impedance of the same anode that has not been subjected to the hydrophilization treatment.

In another aspect, the real component of the impedance of the anode of the present invention after 10 minutes of immersion in 6.6 M KOH may be not larger than about 3 Ohm·cm² and/or may be not larger than about 2 Ohm·cm² after 20 minutes of immersion in 6.6 M KOH.

In another aspect, the anode may be substantially completely wetted by 6.6 M KOH of room temperature within not more than about 60 minutes.

In yet another aspect, that surface of the anode of the present invention which is intended to contact a liquid electrolyte (opposite the side that is intended to contact the liquid fuel) may be substantially completely covered with a polymeric material that is capable of substantially preventing hydrogen gas to pass through the anode. For example, the polymeric material may comprise at least one polymer with a hydrophilic functional group selected from OH, COOH and SO₃H. In one aspect, the polymeric material may comprise a homopolymer and/or a copolymer of vinyl alcohol, e.g., a copolymer of vinyl alcohol and ethylene. In another aspect, the at least one polymer may be at least partially crosslinked with a crosslinking agent. For example, the at least one polymer may comprise a polymer having OH groups (e.g., a homo- or copolymer of vinyl alcohol) and the crosslinking agent may comprise a polymer selected from polyethylene glycol, polyethylene oxide, a homo- or copolymer of acrylic acid and combinations of two or more thereof and/or the crosslinking agent may comprise one or more of a silicate, a pyrophosphate, a sugar alcohol, a polycarboxylic acid and an aldehyde.

The present invention also provides a liquid fuel cell which comprises the anode of the present invention, including the various aspects thereof as set forth above.

In one aspect, the fuel cell may be a direct liquid fuel cell and/or a portable fuel cell (e.g. for use with cell phones, laptops and the like).

In another aspect, the fuel cell may comprise a metal hydride and/or a metal borohydride compound (e.g., as an alkaline aqueous solution thereof, for example, sodium borohydride, in a fuel chamber thereof and/or it may comprise an aqueous alkali metal hydroxide (e.g., NaOH and/or KOH) in an electrolyte chamber thereof.

The present invention also provides a fuel cell for use with a liquid fuel that comprises water and/or a hydrophilic solvent. The fuel cell comprises a cathode, an anode, an electrolyte chamber arranged between the cathode and the anode, a fuel chamber arranged on the side of the anode which is opposite to the side which faces the electrolyte chamber. At least a part of the side of the anode which faces the fuel chamber has been subjected to a hydrophilization treatment.

In one aspect, the fuel chamber may contain a fuel that comprises at least one of a metal hydride compound and a metal borohydride compound.

In another aspect of the fuel cell, the hydrophilization treatment may comprise a treatment with a hydrophilizing agent.

In yet another aspect, the anode may comprise one or more hydrophilizing agents in a total amount of from about 0.01 to about 1 mg/cm². The hydrophilizing agent may comprise, for example, at least one substance selected from anionic surfactants, cationic surfactants, non-ionic surfactants, polycarboxylic acids and salts thereof, oxy-acids and salts thereof, sugars, sugar alcohols, sugar derivatives and cellulose derivatives.

In yet another aspect of the fuel cell, the real component of the impedance of the anode after 10 minutes of immersion in 6.6 M KOH may be not larger than about 3 Ohm·cm² and/or the anode may be substantially completely wetted after immersion in 6.6 M KOH at room temperature within not more than about 60 minutes.

The present invention also provides a method of increasing the fuel wetting rate of an anode for use in a liquid fuel cell which uses a fuel that comprises at least one of water and/or a hydrophilic (organic) solvent (e.g., an alcohol such as methanol and ethanol). The method comprises subjecting at least a part of the side of the anode that is intended to contact the liquid fuel (e.g., at least a portion of the side of the finished anode that is intended to contact the liquid fuel) to a hydrophilization treatment.

In one aspect of this method, the hydrophilization treatment may comprise a treatment with a hydrophilizing agent. Non-limiting examples of hydrophilizing agents include anionic surfactants, cationic surfactants, non-ionic surfactants, polycarboxylic acids and salts thereof, oxy-acids and salts thereof, sugars, sugar alcohols, sugar derivatives and cellulose derivatives.

In another aspect of the method, the hydrophilization treatment may result in a decrease of the real component of the impedance for an anode that is immersed for 10 minutes in 6.6 M KOH solution by at least 50%.

In yet another aspect, the real component of the impedance of the hydrophilized anode after a 20 minute immersion of the anode in 6.6 M KOH solution may be not higher than about 2 Ohm·cm².

The present invention also provides a method of decreasing the induction period of an anode of a liquid fuel cell which uses a liquid fuel that comprises water and/or a hydrophilic solvent. The method comprises subjecting at least a part of the side of the anode that is intended to contact the liquid fuel (e.g., at least a portion of the side of the finished anode that is intended to contact the liquid fuel) to a hydrophilization treatment.

The present invention also provides a method of hydrophilizing a material for use in an anode of a liquid fuel cell, wherein the method comprises contacting a two-dimensional material which comprises catalytically active metal on a porous support and binder with a solution of one or more hydrophilizing substances selected from anionic surfactants, cationic surfactants, non-ionic surfactants, polycarboxylic acids and salts thereof, oxy-acids and salts thereof, sugars, sugar alcohols, sugar derivatives and cellulose derivatives.

In one aspect of the method, the material may be contacted with the solution for a sufficient time and at a sufficient temperature to obtain a material which after drying comprises from about 0.01 mg/cm² to about 1 mg/cm² of the one or more hydrophilizing substances.

In another aspect of the above method, the catalytically active metal may comprise one or more of Pt, Pd, Rh, Ru, Ir, Au and Re, and/or the support may comprise one or more of activated carbon, carbon black, graphite and carbon nanotubes, and/or the binder may comprise PTFE.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic cross section view of a fuel cell which includes an anode according to the present invention;

FIG. 2 shows a schematic cross section view of the fuel cell of FIG. 1 which additionally includes a gas blocking layer on the anode;

FIG. 3 shows a plot of the real component of the impedance Z′ vs time for an anode of the present invention and a comparative anode.

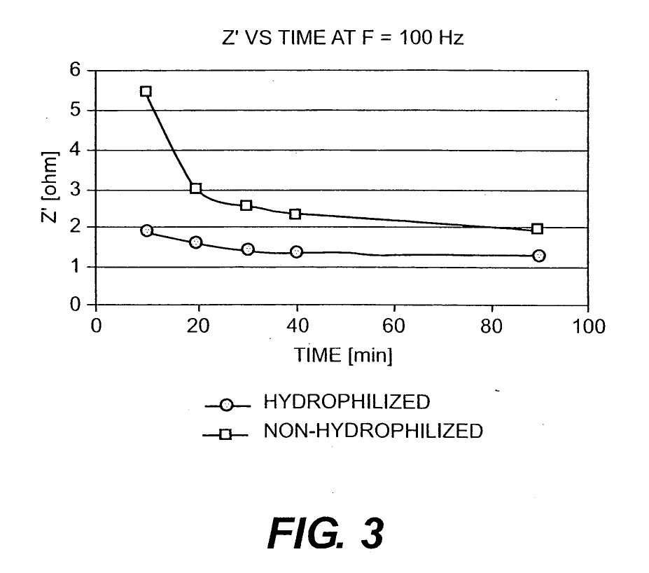

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

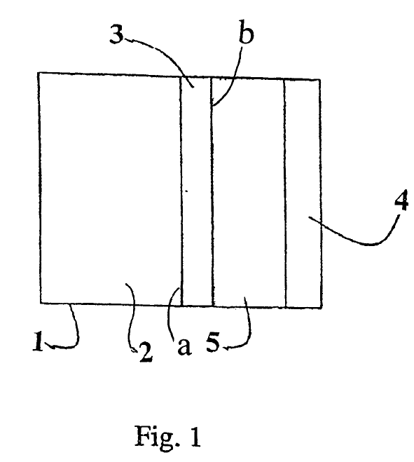

As illustrated in FIG. 1, a liquid fuel cell according to the present invention comprises a casing or container body 1 which comprises therein a fuel chamber 2 and an electrolyte chamber 5. Fuel chamber 2 contains hydrophilic liquid fuel in the form of, e.g., an alkaline aqueous solution of a hydride or borohydride compound such as sodium borohydride. Non-limiting examples of corresponding liquid fuels are described in, e.g., US 20010045364 A1, U.S. 20030207160 A1, US 20030207157 A1, U.S. 20030099876 A1, and U.S. Pat. Nos. 6,554,877 B2 and 6,562,497 B2, the entire disclosures whereof are expressly incorporated by reference herein.

The electrolyte chamber contains electrolyte in the form of, e.g., an aqueous alkali metal hydroxide (e.g., NaOH and/or KOH). An anode 3 is arranged within casing 1 and separates the two chambers 2 and 5. A cathode 4 (e.g., an air-breathing cathode) is also arranged in casing 1 and, together with anode 3, defines electrolyte chamber 5. At anode 3 an oxidation of the liquid fuel takes place. At cathode 4 a substance, typically oxygen in ambient air, is reduced. At least a part of anode 3 which faces fuel chamber 2 has been subjected to a hydrophilization treatment. For example, at least a part of side a in FIG. 1 (preferably, substantially the entire side a) of anode 3 may have been subjected to a hydrophilization treatment. The opposite side of anode 3 (side b in FIG. 1) may also have been subjected to a hydrophilization treatment.

In a conventional liquid fuel cell without the anode of the present invention, it will usually take a considerable period of time (often in excess of one hour) for the hydrophilic fuel to wet the anode substantially completely (this period is referred to herein as the “induction period”). Accordingly, the power output and the efficiency of the fuel cell will reach their maximum level only after a considerable induction period. In the anode according to the present invention (at least) a part of the anode that is to contact the liquid fuel has been subjected to a hydrophilization treatment, which increases the fuel wetting rate of the anode surface by a hydrophilic liquid fuel and thereby decreases the induction period (often to less than about 60 minutes, e.g., less than about 40 minutes, or even less than about 30 minutes). It often shortens the induction period by at least about 50%, e.g., at least about 70%.

The anode of the present invention may be any anode which is suitable for a (direct) liquid fuel cell that uses a hydrophilic fuel. The anode will usually comprise a porous material and may have been produced by wet or dry technologies. Of course, the materials of the anode should be able to withstand the chemical attack by the liquid fuel and the electrolyte and should not catalyze a decomposition of the fuel to any appreciable extent. A non-limiting example of an anode for use in the present invention comprises a metal mesh current collector, e.g., a nickel or stainless steel mesh, which has attached to it a porous active layer. This active layer may comprise, by way of non-limiting example, activated carbon carrying a catalytically active material (such as a metal, for example, Pt, Pd, Ru, Rh, Ir, Re and Au to name just a few), and a binder, typically a polymeric material such as, e.g., polytetrafluoroethylene. Of course, other and/or additional materials may be used for making the anode. For example, instead of the metal mesh, a metal foam, or hydrophilic carbon paper may be used.

As set forth above, according to the present invention, at least a part of the side of the anode, e.g., at least a part of one side (major surface) thereof, is subjected to a hydrophilization treatment. The hydrophilization treatment may comprise any treatment which renders the anode hydrophilic or more hydrophilic without adversely affecting, to any significant extent, desirable properties of the anode such as, e.g., electrocatalytic activity, mechanical integrity and electric conductivity of the active layer.

In this regard, it is to be appreciated that according to the present invention it is not necessary (although preferred) to subject substantially the entire side of a finished anode that is intended to contact a liquid fuel to a hydrophilization treatment. Hydrophilizing only a part of the side that is intended to contact the liquid fuel is sufficient as long as this affords an anode with substantially improved characteristics such as, e.g., substantially reduced induction period and/or substantially improved power output during the initial period of contact between anode and liquid fuel, etc., in comparison to the same anode that has not been subjected to any hydrophilization treatment at all.

By the same token, according to the present invention it is not necessary to hydrophilize the finished (ready-to-use) anode (or a part or side thereof, respectively). Rather, it may be sufficient to hydrophilize merely one or more components that are to be used for manufacturing the anode. By way of non-limiting example, all or at least a part of the support for carrying the catalytically active species (e.g., a catalytically active metal) may be subjected to a hydrophilization treatment (before or after loading it with the catalytically active species), whereafter it may be combined with the other material(s) used for making the anode (e.g., a binder).

Of course, according to the present invention it is also possible to combine different hydrophilization methods. For example, the support may first be hydrophilized, an anode may be manufactured by using the hydrophilized support with the catalytically active species thereon, and thereafter the finished anode (or at least a part of the side thereof that is intended to contact the liquid fuel) may be subjected to a (further) hydrophilization treatment. By way of further example, the anode or a part thereof may first be subjected to a treatment with one or more hydrophilizing agents, followed by cold plasma etching. Also, a treatment of the anode with a first hydrophilizing agent may be followed by a treatment of the anode with a second hydrophilizing agent, or two or more hydrophilizing agents can be used at the same time. In other words, any method and combination of methods that renders (at least) a part of the side of the anode that is intended to come into contact with liquid fuel hydrophilic or more hydrophilic, respectively, can be used for the purposes of the present invention.

Non-limiting examples of hydrophilization treatments which are suitable for the purposes of the present invention include a treatment with one or more hydrophilizing agents, (cold) plasma etching, heating in an oxidative atmosphere, etching in oxidant solutions, strong chemisorption, etc. As pointed out above, any combinations of suitable hydrophilization treatments may be employed as well. According to the present invention, “soft” hydrophilization treatments such as, e.g., treatment with one or more hydrophilizing agents and cold plasma etching are preferred. Preferred is an impregnation of the anode with a (preferably aqueous) solution of one or more hydrophilizing agents which preferably results in a weak adsorption thereof on the catalyst particles.

In the case of hydrophilizing the finished anode or a part thereof with hydrophilizing agents, since the active layer of the anode usually comprises a porous structure including micro-, meso- and macro-pores, the molecules of the hydrophilizing agent(s) should not be too large to enable them to diffuse into the macro- and meso-pores within a relatively short period of time. On other hand, these molecules should not be too volatile and/or too small so as to not be trapped in the pores of the active layer.

The method by which the anode or any part or component thereof is treated (impregnated) is not particularly limited as long as it affords the desired result. For example, a solution (e.g., an aqueous solution or an aqueous organic solution) of the hydrophilizing agent(s) may be applied to at least that side of the anode (or at least a part thereof, respectively) which is to be contacted with the liquid fuel (i.e., side a in FIG. 1) by spraying, brushing, dipping etc., followed by holding the anode in contact with the solution (preferably at elevated temperature) to enable the hydrophilizing agent(s) to diffuse into the pores of the active layer. In a preferred method, the anode is immersed into a (preferably heated) solution of the hydrophilizing agent(s) and kept therein for a sufficient period of time to allow diffusion of the hydrophilizing agent(s) into the active layer. Thereafter the anode is removed from the solution and dried. This immersion method will afford an anode wherein both major surfaces thereof (i.e., sides a and b in FIG. 1) have been subjected to a hydrophilization treatment.

By way of non-limiting example, the (preferably aqueous) solution may have a concentration of hydrophilizing agent(s) of from about 0.001% to about 5% by weight, e.g., from about 0.01% to about 1% by weight, and the solution may have a temperature of from about 40° C. to about 90° C., with a residence time of the anode in the solution of from about 5 minutes to about 2 hours. Drying conditions may, for example, include drying in air at a temperature of from about 70° C. to about 100° C. for about 10 minutes to about 2 hours. Of course, these conditions are given merely for illustrative purposes and considerably different times, temperatures and concentrations than those indicated herein may afford even more desirable results under certain circumstances.

The amount of hydrophilizing agent(s) that is left on and inside the anode (or one or more components thereof) is not particularly limited as long as this amount affords the desired result, i.e., rendering the anode (or the part thereof, respectively, that will contact the liquid fuel) hydrophilic or more hydrophilic, respectively without significantly impairing other desirable properties of the anode. For example, the amount will often be not less than about 0.001 mg/cm², e.g., not less than about 0.01 mg/cm², not less than about 0.05 mg/cm², or not less than about 0.1 mg/cm² of hydrophilized surface area. On the other hand, the amount will often be not higher than about 5 mg/cm², e.g., not higher than about 1 mg/cm², or not higher than about 0.5 mg/cm².

Examples of hydrophilizing agents which are suitable for the purposes of the present invention include substances which provide the anode with hydrophilic groups such as, e.g., OH, COOH, SO₃H and amino groups. Often, these substances will exhibit a substantial solubility in water, although this is not a prerequisite. Further, they should be able to withstand a drying operation at elevated temperatures (for example, they should have a sufficiently low vapor pressure at elevated temperatures so as to not readily evaporate upon drying the anode or a component thereof). Non-limiting examples of such substances include non-ionic, cationic, anionic and amphoteric surfactants, mono- and polycarboxylic acids and salts thereof, oxy-acids and salts thereof, sulfonic acids and salts thereof, polyols, hydroxyacids and salts thereof, amines and salts thereof, aminoalcohols, aminoacids, sugars, sugar alcohols, sugar derivatives, and cellulose derivatives.

Non-limiting specific examples of hydrophilizing agents which are suitable for the purposes of the present invention include alkyl sulfates, alkyl sulfonates, alkyl ether sulfates, polyalkylene glycols and polyalkylene glycol mono- and diethers (e.g., based on C₁₋₆ alkylene glycols such as, e.g., di- tri- and tetraethylene glycol, di- tri and tetrapropylene glycol and polyethylene/propylene glycol, preferably having a weight average molecular weight of not more than about 1,000), homo- and copolymers of acrylic acid, optionally in partly or completely neutralized form (e.g., copolymers of acrylic acid and one or more of maleic acid and methacrylic acid), monomeric polycarboxylic acids and salts thereof (e.g., the alkali and alkaline earth metal salts, particularly the Na and K salts) such as, e.g., oxalic acid, succinic acid, sulfosuccinic acid, glutaric acid, and adipic acid, etc., oxy-acids (e.g., monocarboxylic acids) and salts thereof (e.g., the Na and K salts), polyols such as, e.g., glycerol, pentaerythritol and trimethylolpropane, hydroxyacids and salts thereof such as, e.g., lactic acid, dimethylolpropionic acid, citric acid, malic acid and tartaric acid, aminoalcohols and salts thereof such as, e.g., mono- di- and triethanolamine, sugars such as, e.g., glucose, fructose, xylose, sorbose, sucrose, maltose, lactose and galactose, sugar alcohols such as, e.g., sorbitol, xylitol, mannitol, maltitol, lactitol, galactitol and erythritol, sugar derivatives such as, e.g., sugar acids (e.g., gluconic acid) and cellulose derivatives such as, e.g., carboxymethyl cellulose and salts thereof (e.g., the Na salt). The hydrophilizing agents can be employed individually or as combination of two or more thereof.

In a preferred aspect of the anode of the present invention, when the anode that has been subjected to one or more hydrophilization treatments is immersed in 6.6 M aqueous KOH of room temperature for 10 minutes, the real component of the impedance (Z′) of the anode (as determined, for example, according to the procedure set forth in the Example below) is not larger than about 50%, e.g., not larger than about 40% of Z′ of the anode without the hydrophilization treatment(s). After 20 minutes of immersion, Z′ preferably is not larger than about 75%, e.g., not larger than about 65% of Z′ of the untreated anode. Also, after 30 minutes of immersion, Z′ preferably is not larger than about 80%, e.g., not larger than about 70% of Z′ of the untreated anode.

In another preferred aspect, Z′ of the hydrophilized anode of the present invention after 10 minutes of immersion in 6.6 M KOH of room temperature is not larger than about 3 Ohm·cm², e.g., not larger than about 2.5 Ohm·cm², and/or is not larger than about 2 Ohm·cm² after 20 minutes, or even after 15 minutes of immersion in 6.6 M KOH.

In yet another preferred aspect, the anode of the present invention is substantially completely wetted (e.g., at least about 98% wetted) by 6.6 M KOH of room temperature within not more than about 60 minutes, e.g., within not more than about 45 minutes. The degree of wetting is determined by comparing the actual value of Z′_{act} with the final value of Z′_{fin} (after complete wetting) according to d_{wet}=Z′_{fin}/Z′_{act}.

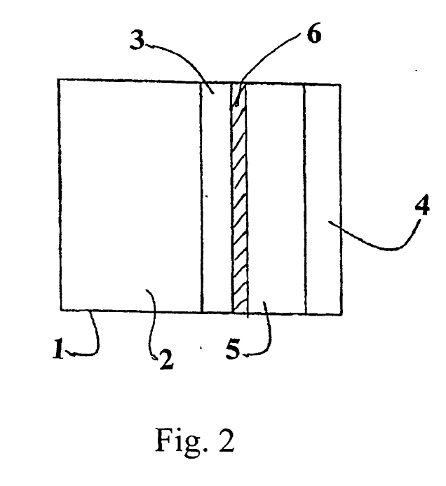

In a still further preferred aspect, the side of the anode which is intended to contact a liquid electrolyte (opposite the side that is intended to contact the liquid fuel), i.e., side b in FIG. 1, may be (substantially completely) covered with a (preferably polymeric) material that is capable of substantially preventing hydrogen gas to pass through the anode. A corresponding embodiment is schematically illustrated in FIG. 2, which shows a gas blocking layer 6 on that side of the anode 3 which faces the electrolyte chamber 5 (side b in FIG. 1). The gas blocking material is preferably provided because hydrogen gas that may be generated as a decomposition product of the liquid fuel at the anode has a tendency to pass through the porous anode material into the electrolyte chamber in the form of fine bubbles, leading to the formation of hydrogen bubbles in the (liquid) electrolyte and, in turn, to an increase of the electrical resistance of the electrolyte. Details regarding the material and the methods for providing the anode with the material are described in co-pending U.S. application Ser. No. 10/959,763, filed Oct. 7, 2004, and a co-pending U.S. application entitled “GAS BLOCKING ANODE FOR A DIRECT LIQUID FUEL CELL”, filed concurrently with the present application (attorney docket P29025), the entire disclosures whereof are expressly incorporated by reference herein.

For example, the polymeric material may comprise at least one polymer with a functional group selected from OH, COOH and SO₃H. In one aspect, the polymeric material may comprise a homopolymer and/or a copolymer of vinyl alcohol, e.g., a copolymer of vinyl alcohol and an alkene such as ethylene. In another aspect, the at least one polymer may be at least partially crosslinked with a crosslinking agent. For example, the at least one polymer may comprise a polymer having OH groups (e.g., a homo- or copolymer of vinyl alcohol) and the crosslinking agent may comprise a polymer selected from polyethylene glycol, polyethylene oxide, a homo- or copolymer of acrylic acid and combinations of two or more thereof thereof and/or the crosslinking agent may comprise one or more of a silicate, a pyrophosphate, a sugar alcohol, a polycarboxylic acid and an aldehyde.

Covering the anode 3 with the polymeric material for the gas blocking layer 6 (either before or after the hydrophilization treatment of the anode) can be accomplished in various ways. For example, one or more films of polymeric material can be attached to the surface of the anode (which surface may have undergone a hydrophilization treatment of the present invention) under pressure and/or by means of a suitable adhesive (applied, e.g. at the edges of the anode). Preferably, the one or more layers of polymeric material 6 are (successively) applied by a coating operation. For example, one or more solutions and/or suspensions of the desired polymeric material(s) may be applied onto the surface of the anode, and after the or each coating operation the solvent(s) may be at least partially removed, e.g., allowing the solvent(s) to evaporate under ambient conditions, by heating and/or by applying a vacuum. The polymeric material does not necessarily have to be in direct contact with the anode surface (although direct contact is preferred), as long as the polymeric material is capable of preventing a substantial portion of the hydrogen gas from entering the electrolyte chamber, and as long as the conductivity of the combination of anode and polymeric layer is not significantly adversely affected by the lack of direct contact.

Where two or more layers of polymeric material (e.g., two, three or four layers of polymeric material) are applied, the layers may comprise the same or different polymer(s). Layers of the same polymer(s) may be of advantage, for example, if a single coating operation does not afford the desired thickness (and/or mechanical strength) of the polymeric material layer and/or if it is difficult to achieve a continuous coating film (substantially without any holes) with a single coating operation.

Two or more layers which comprise different polymers in at least two of the layers may be expedient for, e.g., imparting a combination of desired characteristics to the polymeric material. For example, a first layer of polymeric material which is in direct contact with the anode may comprise one or more polymers which provide a good adhesion to the anode surface, whereas a layer which comprises one or more polymers which is (are) different from the polymer(s) in the first layer and which layer is arranged on the first layer may provide other desired characteristics, for example, a high conductivity. In this regard, it is preferred for the combination of anode and polymeric material to have a resistivity of not substantially higher than about 1 Ohm·cm², even more preferred of not higher than about 0.95 Ohm·cm², particularly not higher than about 0.9 Ohm·cm², not higher than about 0.85 Ohm·cm², or not higher than about 0.8 Ohm·cm².

Irrespective of whether one or two (or more) layers of polymeric material are provided on the anode surface, each of these layers may independently comprise a single polymer or a mixture of two or more polymers. Of course, if two or more layers are provided, these layers may have the same or a different thickness.

The one or more layers of polymeric material arranged on the anode will usually have a combined thickness of not more than about 0.2 mm, e.g., not more than about 0.15 mm. On the other hand, the combined thickness will preferably be not lower than about 0.025 mm, e.g., not lower than about 0.03 mm.

Suitable polymers for use in the one or more layers of polymeric material 6 include those which provide, alone or in combination, both a satisfactory ionic conductivity and a high gas-blocking efficiency (a low permeability for hydrogen gas), particularly in the conventional operating temperature range of a DLFC, i.e., from room temperature to about 60° C. Also, the one or more polymers should provide sufficient mechanical strength and maintain mechanical integrity to a sufficient extent even when exposed to an alkaline solution (in particular, an aqueous electrolyte) at a temperature of up to about 60° C. for extended periods of time. In this regard, an example of an aqueous electrolyte of the type conventionally used in a DLFC is aqueous potassium hydroxide solution (e.g., about 6M to about 7M KOH). Sufficient adhesion to the anode surface is also a desired characteristic. As mentioned above, it is not necessary for a single polymer to exhibit all of these desirable properties in order to be suitable for use in the present invention. A combination of two or more polymers which together provide these properties is equally suitable.

Examples of polymers which provide a satisfactory ionic conductivity include those which are able to dissolve or swell in aqueous solutions. A high gas-blocking efficiency may be achieved, for example, by crosslinking suitable polymer chains, which at the same time will increase the mechanical strength of the polymer layer.

Preferred polymers for use in the present invention include those which comprise one or more types of hydrophilic groups such as, e.g., OH, COOH and/or SO₃H groups. Non-limiting examples of such polymers are homo- and copolymers which comprise units of vinyl alcohol, acrylic acid, methacrylic acid, and the like. Of course, polymers with different hydrophilic groups may also be useful. The term “hydrophilic groups” as used herein and in the appended claims is meant to encompass groups which have affinity for and/or are capable of interacting with, water molecules, e.g., by forming hydrogen bonds, ionic interactions, and the like. Preferred examples of polymers with hydrophilic groups for use in the present invention are polymers which comprise at least OH groups, in particular, the homo- and copolymers of vinyl alcohol.

Non-limiting examples of copolymers of vinyl alcohol comprise units of vinyl alcohol and units of one or more (e.g., one or two) ethylenically unsaturated comonomers. Preferred comonomers include C₂-C₈ alkenes such as, e.g., ethylene, propylene, butene-1, hexene-1, and octene-1. Of course, other comonomers may be used as well such as, e.g., vinylpyrrolidone, vinyl chloride and methyl methacrylate. A particularly preferred comonomer is ethylene. Non-limiting specific examples of suitable copolymers include the Mowiol®, Exceval® and Moviflex® vinyl alcohol/ethylene copolymers which are commercially available from Kuraray Specialities Europe (Frankfurt, Germany), in particular, those with a relatively low ethylene content and/or a degree of hydrolysis of from about 97% to about 99% and/or a degree of polymerization of from about 1,000 to about 2,000 such as, e.g., Exceval® grades RS 1113 and RS 1117 (having degrees of polymerization of about 1,300 and about 1,700, respectively).

In the copolymers of vinyl alcohol (or any other monomer which comprises hydrophilic groups) and comonomers without hydrophilic groups (e.g., alkenes and the like), the vinyl alcohol units will usually provide the desired ionic conductivity, and the comonomer(s) will preferably promote the adhesion of the polymer to the substrate (the anode surface).

In the copolymers of vinyl alcohol, the units of vinyl alcohol are preferably present in an amount of at least about 50 mol %, particularly in copolymers where the comonomer(s) do not comprise any hydrophilic groups.

The average molecular weight of the homo- and copolymers of vinyl alcohol (or any other polymers) for use in the present invention is not particularly critical, but will usually be in the conventional range for this type of polymers, i.e., not significantly higher than about 100,000 and not significantly lower than about 10,000, e.g., not significantly lower than about 30,000 (expressed as weight average molecular weight).

In order to increase the mechanical strength and the gas-blocking efficiency of a polymer with hydrophilic groups for use in the present invention, for example the homo- and copolymers of vinyl alcohol set forth above, it will usually be of advantage to crosslink the polymer chains. Suitable sites for crosslinking include the hydrophilic groups of the polymer molecules and/or any other functionalities (including ethylenically unsaturated bonds) that may be present in the polymer molecules. Suitable crosslinking agents include those which comprise in their molecule at least two (e.g., two, three, four of five) functional groups which are capable of reacting (or at least strongly interacting) with one or more types of functional groups present in the polymer molecule. The reaction between the functional groups preferably comprises a polycondensation (including a polyaddition), an ionic or free radical polymerization, or any other type of reaction which results in the formation of (preferably covalent) bonds between the reactants. The crosslinking agent may be of organic or inorganic nature, monomeric or polymeric, and two or more crosslinking agents may be employed, if desired.

Non-limiting and preferred examples of crosslinking agents for the crosslinking of homo- and copolymers of vinyl alcohol as well as other types of polymers include polymeric crosslinking agents such as, e.g., polyalkylene glycols (e.g., those comprising one or more C₁₋₆ alkylene glycols such as, e.g., ethylene glycol, propylene glycol, butylene glycol and hexylene glycol), preferably polyethylene glycol, polyethylene oxide, homo- and copolymers of ethylenically unsaturated acids such as, e.g., acrylic acid, methacrylic acid and maleic acid, and monomeric species such as, e.g., alkali metal silicates and pyrophosphates (e.g., sodium or potassium silicate and sodium or potassium pyrophosphate), sugar alcohols (e.g., xylitol, sorbitol, etc.), saturated and unsaturated mono- and polycarboxylic acids which may optionally comprise additional functional groups (e.g., oxalic acid, succinic acid, glutaric acid, adipic acid, maleic acid, fumaric acid, sulfosuccinic acid, malic acid, tartaric acid, citric acid, etc.) and carbonyl compounds, in particular, aldehydes (e.g., formaldehyde). Of course, these compounds may optionally employed as precursors and/or derivatives thereof. For example, polycarboxylic acids may be employed as, e.g., anhydrides or esters and in partially or completely neutralized form. These crosslinking agents will usually be employed in the form of a solution. For example, in the case of sulfosuccinic acid, a preferred concentration range is from about 0.1% to about 2% by weight, e.g., from about 0.2% to about 1% by weight.

In the case of polymeric crosslinking agents, the average molecular weight thereof is not particularly critical and commercially available materials may be employed. For example, the number average molecular weight of commercially available polyethylene glycols is typically in the range of from about 300 to about 10,000, whereas for commercially available polyethylene oxide the number average molecular weight is typically in the range of from about 35,000 to about 200,000. In the case of polyacrylic acid, the weight average molecular weight usually ranges from about 2,000 to about 250,000 (they will usually be employed in the form of a solution at a preferred concentration of from about 0.1% to about 3% by weight, e.g., from about 0.5% to about 2% by weight), and in the case of copolymers of acrylic acid and maleic acid, the weight average molecular weight usually ranges from about 2,000 to about 5,000, e.g., around 3,000 (they will usually be employed in the form of a solution at a preferred concentration of from about 0.1% to about 3% by weight, e.g., from about 0.5% to about 2% by weight).

When homo- and/or copolymers of vinyl alcohol are to be crosslinked for the purposes of the present invention, the weight ratio of these polymers and the crosslinking agent(s), e.g., the crosslinking agents set forth above, preferably ranges from about 2:1 to about 1:2. Of course, ratios outside this range may be used as well and, depending on the specific components employed, may even afford more desirable results. One of ordinary skill in the art will be aware of or be able to readily ascertain suitable weight ratios for other polymers and/or other crosslinking agents.

The following non-limiting Example illustrates the production of a hydrophilized anode according to the present invention (without gas blocking layer). The anode is composed of a Ni mesh (40 mesh, wire diameter 0.14 mm, thickness about 400 μm) with an active layer of 80% by weight of catalyst on activated carbon support and 20% by weight of polytetrafluoroethylene (dry technology).

### EXAMPLE

A solution is prepared by dissolving 5 g of D-sorbitol in 1000 ml of de-ionized water under stirring. The solution is heated to 70° C. in a glass beaker by means of heating plate; an anode material strip (180 mm×100 mm) is immersed in the solution and allowed to stay therein for 1 hour. Then the strip is taken out and is transferred to an oven and dried at 90° C. for 1 hour. The amount of sorbitol in anode is 0.06 mg/cm².

The degree of hydrophilization of the resultant anode material is checked by means of electrochemical impedance measurements. The equipment used is an AutoLab Potentiostat/Galvanostat PGSTAT30 (EcoChemie) with Frequency Response Analyzer and 3-electrode glass electrochemical cell. The electrolyte is 6.6 M KOH. The reference electrode is a reversible hydrogen electrode (Hydroflex, Gaskatel). A piece of anode (1 cm×1 cm) is immersed in the electrolyte. Measurements are taken at room temperature at open-circuit potential, at a frequency of 100 Hz and an AC signal amplitude of 10 mV. The value real component of the impedance (Z′) is taken as a measure of the degree of wetting; the lower the value of Z′, the better the wetting. A well wetted anode demonstrates a Z′ value below 2 Ohm·cm². A plot of the wetting kinetics for hydrophilized and non-hydrophilized anodes is shown in FIG. 1. It is seen that the hydrophilized anode becomes well wetted already during the first few minutes of immersion in the KOH solution. In the case of the non-hydrophilized anode it takes more than 80 minutes to afford satisfactory wetting.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. An anode for a liquid fuel cell, wherein at least a part of a side of the anode which is intended to contact a liquid fuel has been subjected to a hydrophilization treatment.

2. The anode of claim 1, wherein the anode comprises a catalytically active metal on a support.

3. The anode of claim 2, wherein the catalytically active metal comprises at least one of Pt, Pd, Rh, Ru, Ir, Au and Re.

4. The anode of claim 2, wherein the support comprises at least one of activated carbon, carbon black, graphite and carbon nanotubes.

5. The anode of claim 2, wherein the anode further comprises a binder.

6. The anode of claim 1, wherein at least a side of the finished anode which is intended to contact a liquid fuel has been subjected to a hydrophilization treatment.

7. The anode of claim 2, wherein at least the support for carrying the catalytically active metal has been subjected to a hydrophilization treatment.

8. The anode of claim 1, wherein the hydrophilization treatment comprises a treatment with a hydrophilizing agent.

9. The anode of claim 8, wherein the hydrophilizing agent comprises at least one substance selected from anionic surfactants, cationic surfactants, non-ionic surfactants, polycarboxylic acids and salts thereof, oxy-acids and salts thereof, sugars, sugar alcohols, sugar derivatives and cellulose derivatives.

10. The anode of claim 8, wherein the hydrophilizing agent comprises at least one substance selected from alkyl sulfates and alkyl sulfonates.

11. The anode of claim 8, wherein the hydrophilizing agent comprises at least one substance selected from polyalkylene glycols and ethers thereof.

12. The anode of claim 11, wherein the weight average molecular weight of the polyalkylene glycols and ethers thereof is not higher than about 1,000.

13. The anode of claim 8, wherein the hydrophilizing agent comprises at least one substance selected from homopolymers and copolymers of acrylic acid, monomeric polycarboxylic acids and salts thereof.

14. The anode of claim 8, wherein the hydrophilizing agent comprises at least one substance selected from glucose, fructose, xylose, sorbose, sucrose, maltose, lactose, galactose, sorbitol, xylitol, mannitol, maltitol, lactitol, galactitol, erythritol and gluconic acid.

15. The anode of claim 8, wherein the hydrophilizing agent comprises at least one substance selected from carboxymethyl cellulose and salts thereof.

16. The anode of claim 8, wherein the anode comprises from about 0.001 to about 5 mg/cm² of hydrophilizing agent.

17. The anode of claim 9, wherein the anode comprises from about 0.05 to about 0.5 mg/cm² of hydrophilizing agent.

18. The anode of claim 1, wherein the hydrophilization treatment comprises cold plasma etching of at least a side of the finished anode which is intended to come into contact with the liquid fuel.

19. The anode of claim 1, wherein a real component of an impedance after 10 minutes of immersion of the anode in 6.6 M aqueous KOH is not larger than about 50% of a real component of an impedance of the same anode that has not been subjected to the hydrophilization treatment.

20. The anode of claim 19, wherein a real component of an impedance after 20 minutes of immersion of the anode in 6.6 M aqueous KOH is not larger than about 75% of a real component of an impedance of the same anode that has not been subjected to the hydrophilization treatment.

21. The anode of claim 19, wherein a real component of an impedance of the anode after 10 minutes of immersion in 6.6 M KOH is not larger than about 3 Ohm·cm².

22. The anode of claim 20, wherein a real component of an impedance of the anode after 20 minutes of immersion in 6.6 M KOH is not larger than about 2 Ohm·cm².

23. The anode of claim 1, wherein the anode is substantially completely wetted by 6.6 M KOH of room temperature within not more than about 60 minutes.

24. The anode of claim 1, wherein a surface of the anode which is intended to contact an electrolyte is substantially completely covered with a polymeric material that is capable of substantially preventing hydrogen gas to pass through the anode.

25. The anode of claim 24, wherein the polymeric material comprises at least one polymer having a functional group selected from OH, COOH and SO₃H.

26. The anode of claim 25, wherein the polymeric material comprises at least one of a homopolymer and a copolymer of vinyl alcohol.

27. The anode of claim 25, wherein the polymeric material comprises a copolymer of vinyl alcohol and an alkene.

28. The anode of claim 25, wherein the at least one polymer is at least partially crosslinked with a crosslinking agent.

29. The anode of claim 28, wherein the at least one polymer comprises a polymer having OH groups and the crosslinking agent comprises a polymer selected from polyethylene glycol, polyethylene oxide, a homo- or copolymer of acrylic acid and combinations of two or more thereof.

30. The anode of claim 28, wherein the at least one polymer comprises a polymer having OH groups and the crosslinking agent comprises at least one of a silicate, a pyrophosphate, a sugar alcohol, a polycarboxylic acid and an aldehyde.

31. A liquid fuel cell which comprises the anode of claim 1.

32. The fuel cell of claim 31, wherein the fuel cell is a direct liquid fuel cell.

33. The fuel cell of claim 31, wherein the fuel cell is portable.

34. The fuel cell of claim 33, wherein the fuel cell comprises at least one of a metal hydride and a metal borohydride compound in a fuel chamber thereof.

35. The fuel cell of claim 31, wherein the fuel cell comprises sodium borohydride in a fuel chamber thereof.

36. The fuel cell of claim 31, wherein an electrolyte chamber thereof comprises an aqueous alkali metal hydroxide.

37. A fuel cell for use with a liquid fuel that comprises at least one of water and a hydrophilic liquid, the fuel cell comprising:
a cathode;
an anode;
an electrolyte chamber arranged between the cathode and the anode; and
a fuel chamber arranged on a side of the anode which is opposite to a side which faces the electrolyte chamber;
wherein at least a part of the side of the anode which faces the fuel chamber has been subjected to a hydrophilization treatment.

38. The fuel cell of claim 37, wherein the fuel chamber contains a fuel that comprises at least one of a metal hydride compound and a metal borohydride compound.

39. The fuel cell of claim 37, wherein the hydrophilization treatment comprises a treatment with a hydrophilizing agent.

40. The fuel cell of claim 39, wherein the anode comprises hydrophilizing agent in an amount of from about 0.01 to about 1 mg/cm².

41. The fuel cell of claim 40, wherein the hydrophilizing agent comprises at least one substance selected from anionic surfactants, cationic surfactants, non-ionic surfactants, polycarboxylic acids and salts thereof, oxy-acids and salts thereof, sugars, sugar alcohols, sugar derivatives and cellulose derivatives.

42. The fuel cell of claim 39, wherein a real component of an impedance of the anode after 10 minutes of immersion in 6.6 M KOH is not larger than about 3 Ohm·cm².

43. The fuel cell of claim 42, wherein the anode is substantially completely wetted after immersion in 6.6 M KOH at room temperature within not more than about 60 minutes.

44. A method of increasing the wetting rate of an anode for use in a liquid fuel cell which uses a fuel that comprises at least one of water and a hydrophilic liquid, wherein the method comprises subjecting at least a part of a side of the anode that is intended to contact the liquid fuel to a hydrophilization treatment.

45. The method of claim 44, wherein the hydrophilization treatment comprises a treatment with a hydrophilizing agent.

46. The method of claim 45, wherein the hydrophilizing agent comprises at least one substance selected from anionic surfactants, cationic surfactants, non-ionic surfactants, polycarboxylic acids and salts thereof, oxy-acids and salts thereof, sugars, sugar alcohols, sugar derivatives and cellulose derivatives.

47. The method of claim 44, wherein the hydrophilization treatment decreases a real component of an impedance of an anode that is immersed for 10 minutes in 6.6 M KOH solution by at least 50%.

48. The method of claim 44, wherein a real component of an impedance of the hydrophilized anode after a 20 minute immersion of the anode in 6.6 M KOH solution is not higher than about 2 Ohm·cm².

49. A method of decreasing an induction period of an anode of a liquid fuel cell which uses a liquid fuel that comprises at least one of water and a hydrophilic liquid, wherein the method comprises subjecting at least a part of a side of the anode that is intended to contact the liquid fuel to a hydrophilization treatment.

50. A method of hydrophilizing a material for use in an anode of a liquid fuel cell, wherein the method comprises contacting a two-dimensional material which comprises binder and catalytically active metal on a porous support with a solution of one or more hydrophilizing substances selected from anionic surfactants, cationic surfactants, non-ionic surfactants, polycarboxylic acids and salts thereof, oxy-acids and salts thereof, sugars, sugar alcohols, sugar derivatives and cellulose derivatives.

51. The method of claim 50, wherein the material is contacted with the solution for a sufficient time and at a sufficient temperature to obtain a material which after drying comprises from about 0.01 to about 1 mg/cm² of the one or more hydrophilizing substances.

52. The method of claim 50, wherein the catalytically active metal comprises at least one of Pt, Pd, Rh, Ru, Ir, Au and Re, the support comprises at least one of activated carbon, carbon black, graphite and carbon nanotubes, and the binder comprises PTFE.
